(19) United States
(12) Patent Application Publication
(10) Pub. No.: US 2017/0165823 A1
(43) Pub. Date: Jun. 15, 2017

(54) DAMPING SYSTEM FOR A HYDRAULIC HAMMER

(71) Applicant: Caterpillar Inc., Peoria, IL (US)

(72) Inventors: Dimitar Dostinov, Hewitt, TX (US); Steven B. Ellis, Hewitt, TX (US)

(73) Assignee: Caterpillar Inc., Peoria, IL (US)

(21) Appl. No.: 14/969,311

(22) Filed: Dec. 15, 2015

(51) Int. Cl. B25D 17/24; B25D 9/00

(52) U.S. Cl. CPC B25D 17/245; B25D 9/00; B25D 2217/0073

(57) ABSTRACT

A damping system for a hydraulic hammer is disclosed. The hydraulic hammer includes a housing and a mounting bracket disposed on the housing. The damping system includes an expandable bladder positioned between the power cell and the mounting bracket. The expandable bladder is configured to receive a supply of pressurized fluid and store a threshold volume of pressurized fluid therein. The damping system includes a plurality of sensors for detecting one or more parameters related to operating conditions of the hydraulic hammer. The damping system includes a controller disposed in communication with the sensors. The controller is configured to receive one or more inputs indicative of the parameters from the sensors to determine a threshold volume of pressurized fluid to be maintained in the expandable bladder. The controller is configured to supply the threshold volume of pressurized fluid to the expandable bladder during an operation of the hydraulic hammer.

### TECHNICAL FIELD

The present disclosure generally relates to a hydraulic hammer. More particularly, the present disclosure relates to a damping system for the hydraulic hammer.

### BACKGROUND

Hydraulic hammers are used at various work sites for removing material from a work surface, for example, for breaking objects, such as rocks, concrete, asphalt, frozen ground, and other materials. The hydraulic hammers may be mounted on a machine, such as a backhoe, an excavator, a dozer, a loader, a motor grader, and the like. Typically, the hydraulic hammers include a housing, a power cell enclosed within the housing, and a mounting bracket disposed on the housing. The power cell is positioned within the housing and coupled with the tool that extends out of the housing. The power cell may be operated pneumatically or hydraulically for actuating the tool for performing various operations on the work surface. Vibrations are created as a result of continuous operation of the power cell and the tool and they may be transferred to a frame of the machine. Therefore, the hydraulic hammers may employ one or more dampers to dampen such vibrations.

For reference, U. S. Publication Number 2013/0306834 describes a vibration dampening device. The vibration dampening device includes a first section having a first section support assembly for supporting vibratory equipment. The vibration dampening device also includes a second section having a section support assembly for allowing vibration dampening device to be supported by a support apparatus. The vibration dampening further includes one or more fluid absorbers located between the first and second sections. The one or more fluid fillable absorbers are configured to absorb at least a portion of a vibratory force transferred from operation of the vibratory equipment.

### SUMMARY OF THE DISCLOSURE

In an aspect of the present disclosure, a damping system for a power cell of a hydraulic hammer is disclosed. The hydraulic hammer has a housing and a mounting bracket disposed on a top side of the housing. The damping system includes an expandable bladder that is positioned between the power cell and the mounting bracket. The expandable bladder is configured to receive a supply of pressurized fluid and store a volume of pressurized fluid therein. The damping system also includes a plurality of sensors for detecting one or more parameters related to operating conditions of the hydraulic hammer. The damping system further includes a controller disposed in communication with the plurality of sensors. The controller is configured to receive a one or more inputs indicative of the one or more parameters from the plurality of sensors to determine a threshold volume of pressurized fluid to be maintained in the expandable bladder. The controller is also configured to supply the threshold volume of pressurized fluid to the expandable bladder during operation of the hydraulic hammer.

In another aspect of the present disclosure, a hydraulic hammer system is disclosed. The hydraulic hammer system includes a hydraulic hammer. The hydraulic hammer includes a housing, a power cell disposed within the housing, and a mounting bracket disposed on a top side of the housing. The hydraulic hammer system further includes a damping system for damping vibrations during operation of the hydraulic hammer. The damping system includes an expandable bladder that is positioned between the power cell and an underside of the mounting bracket. The expandable bladder is configured to receive a supply of pressurized fluid and store the threshold volume of pressurized fluid therein. The damping system also includes a plurality of sensors for detecting one or more parameters related to operating conditions of the hydraulic hammer. The damping system further includes a controller disposed in communication with the plurality of sensors. The controller is configured to receive a one or more inputs indicative of the one or more parameters from the plurality of sensors to determine a threshold volume of pressurized fluid to be maintained in the expandable bladder. The controller is also configured to supply the threshold volume of pressurized fluid to the expandable bladder during operation of the hydraulic hammer.

In yet another aspect of the present disclosure, a machine for penetrating work surface is disclosed. The machine includes a hydraulic hammer system. The hydraulic hammer system includes a hydraulic hammer. The hydraulic hammer includes a housing, a mounting bracket disposed on a top side of the housing, and a power cell disposed within the housing. The hydraulic hammer system further includes a damping system for damping vibrations during operation of the power cell. The damping system includes an expandable bladder that is positioned between the power cell and the mounting bracket. The expandable bladder is configured to receive a supply of pressurized fluid and store a volume of pressurized fluid therein. The damping system also includes a plurality of sensors for detecting one or more parameters related to operating conditions of the hydraulic hammer. The damping system further includes a controller disposed in communication with the plurality of sensors and the pump. The controller is configured to receive one or more inputs indicative of the one or more parameters from the plurality of sensors to determine a threshold volume of pressurized fluid to be maintained in the expandable bladder. The controller is also configured to supply the threshold volume of pressurized fluid to the expandable bladder during operation of the hydraulic hammer by actuating the pump.

Other features and aspects of this disclosure will be apparent from the following description and the accompanying drawings.

### BRIEF DESCRIPTION OF THE DRAWINGS

FIG. 1 is a side view of an exemplary machine using a hydraulic hammer, in accordance with an embodiment of the present disclosure;

FIG. 2 is a diagrammatic view of the hydraulic hammer, in accordance with an embodiment of the present disclosure;

FIG. 3 is an exploded view of the hydraulic hammer, in accordance with an embodiment of the present disclosure; and

FIG. 4 is an exploded view of the hydraulic hammer, in accordance with another embodiment of the present disclosure.

### DETAILED DESCRIPTION

Wherever possible, the same reference numbers will be used throughout the drawings to refer to same or like parts. Moreover, references to various elements described herein are made collectively or individually when there may be more than one element of the same type. However, such references are merely exemplary in nature. It may be noted that any reference to elements in the singular is also to be construed to relate to the plural and vice-versa without limiting the scope of the disclosure to the exact number or type of such elements unless set forth explicitly in the appended claims.

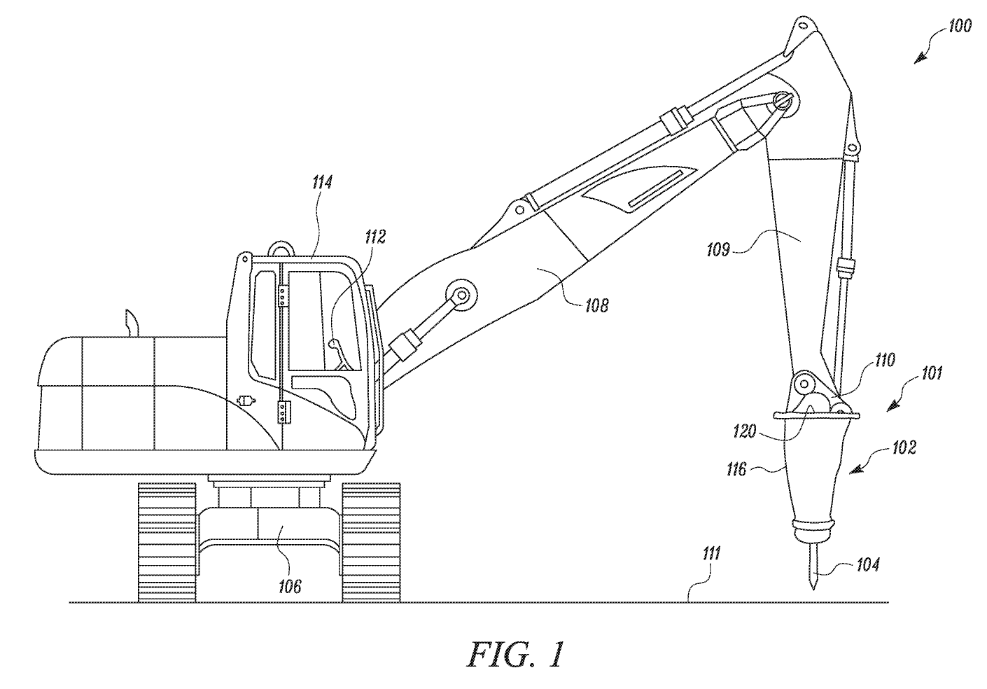

FIG. 1 shows a side view of an exemplary machine 100. The machine 100 employs a hydraulic hammer system 101 shown in accordance with an embodiment of the present disclosure. The hydraulic hammer system 101 includes a hydraulic hammer 102 having a pecking tool 104 that is configured to break rocks and penetrate ground surfaces in various applications associated with industries, such as agriculture, construction, mining, and the like.

In the illustrated embodiment of FIG. 1, the machine 100 is embodied in the form of a tracked industrial vehicle such as an excavator, wherein the hydraulic hammer 102 is mounted to replace an excavator bucket (not shown) previously associated with the excavator. Consequently, the hydraulic hammer 102 may be beneficially operated by the excavator's hydraulics. Alternatively, the hydraulic hammer 102 may be operated by the machine's pneumatic system. However, it may be contemplated that other types of machines and carriers to power the hydraulic hammer 102 may be used in accordance with the present disclosure.

As shown in FIG. 1, the machine 100 includes a frame 106 and one or more linkages 108, 109 pivotally connected to the hydraulic hammer 102 to the linkage 109. The linkages 108, 109 may be articulated relative to the frame 106 in order to change an angular orientation “Q” of the hydraulic hammer 102 with respect to a ground surface 111 during operation of the hydraulic hammer 102. The machine 100 includes a control implement 112 that may be located within a cab 114. The control implement 112 may be used by an operator to control functions of the hydraulic hammer 102.

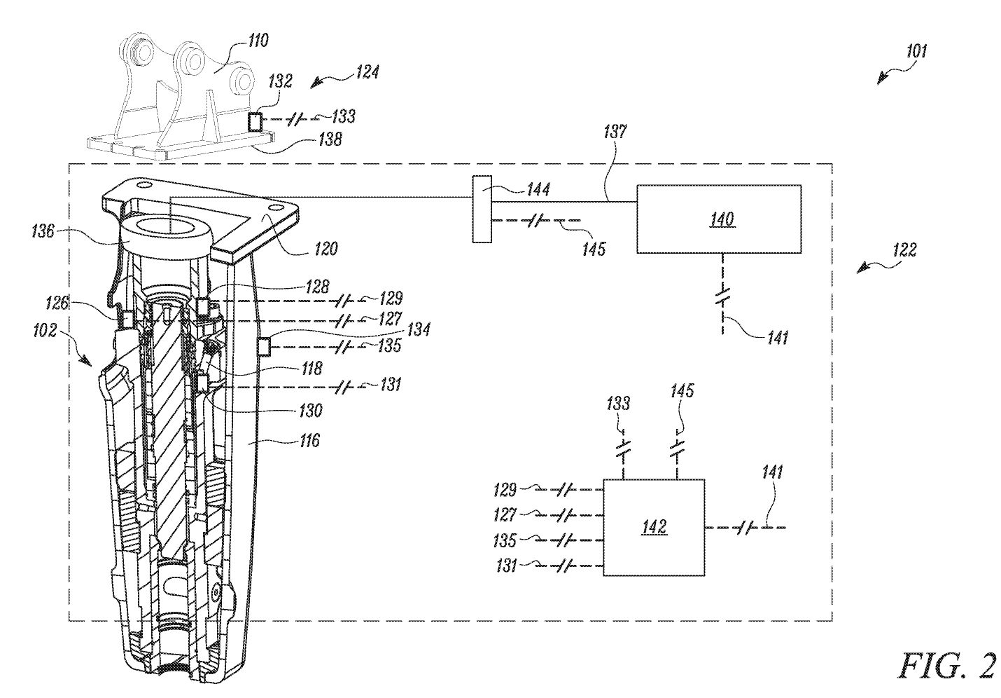

Referring to FIG. 2, a schematic view of the hydraulic hammer 102 is rendered in accordance with an embodiment of the present disclosure. The hydraulic hammer 102 includes a housing 116 enclosing a power cell 118, and a mounting bracket 110 disposed on a top side 120 of the housing 116. The power cell 118 is configured to actuate the pecking tool 104 of the hydraulic hammer 102 so that the pecking tool 104 may perform functions that are consistent with the present disclosure. In an embodiment, the pecking tool 104 is configured to penetrate the ground surface 111 by breaking rocks and other objects.

The power cell 118 may include a cylinder (not shown) and a piston (not shown) slidably received within the cylinder. The power cell 118 may receive the hydraulic fluid at an inlet pressure “P” to move the piston during operation of the hydraulic hammer 102. In turn, the piston pushes the pecking tool 104 to engage with the ground surface 111 based on the inlet pressure “P”. Depending on the inlet pressure “P”, an impact of the piston on the pecking tool 104 may cause a shock wave that fractures any hard object causing it to break apart. Thus, the inlet pressure “P” may be varied based on various ground properties, for example soil resistance, during operation of the hydraulic hammer 102.

In an embodiment, the pecking tool 104 is configured to penetrate the ground surface 111 by impacting the ground surface 111 repeatedly at predefined time intervals. As such, an impact frequency “F” of the hydraulic hammer 102 may be defined based on a number of such impacts within a given duration of time. During operation of the hydraulic hammer 102, the impact frequency “F” of the hydraulic hammer 102 may be varied depending upon on various ground surface properties, such as soil resistance.

Since, the ground surface properties may vary with penetration of the pecking tool 104 within the ground surface 111, vibrations and/or stresses generated due to movement and impact of the pecking tool 104 may also vary i.e. increase and/or decrease. Also, the ground surface properties may change with different applications such as, a mine-site application, a construction site application and the like. Hence, an operating condition of the hydraulic hammer 102 may be defined with respect to ground surface properties.

As shown in FIG. 2, the hydraulic hammer system 101 further includes a damping system 122. The damping system 122 is provided for damping vibrations and/or stresses generated due to movement and impact of the pecking tool 104 during operation of the hydraulic hammer 102. The damping system 122 of the present disclosure is configured to dampen the vibrations based on the operating conditions, for example, the impact frequency “F”, the inlet pressure “P”, during operation of the hydraulic hammer 102. The damping system 122 includes a plurality of sensors 124 disposed on and within the hydraulic hammer 102, at plurality of predetermined locations. Each of the plurality of sensors 124 is configured to detect one or more parameters related to the operating conditions of the hydraulic hammer 102 during operation of the hydraulic hammer 102. In an embodiment, the operating conditions of the hydraulic hammer 102 may be defined with reference to the ground surface properties, that, as discussed earlier, may vary during operation of the hydraulic hammer 102. In such a case, the sensors 124 may be configured to generate a one or more inputs indicative of the operating conditions. In an embodiment, the sensors 124 may detect the one or more parameters such as an acceleration “A” of the power cell 118, the inlet pressure “P”, the angular orientation “Q” of the hydraulic hammer 102, an acceleration “B” of the mounting bracket 110, the impact frequency “F” of the hydraulic hammer 102. In alternative embodiments of the present disclosure, the plurality of sensors 124 may detect other parameters, such as wear extent of the mounting bracket 110. Accordingly, the sensors 124 may include one or more of a proximity sensor, an angle sensor, a camera, a radar proximity sensor or any other sensor to generate a one or more inputs indicative of the operating conditions of the hydraulic hammer 102.

In the illustrated embodiment, the plurality of sensors 124 include a first acceleration sensor 126, a frequency measuring sensor 128, a pressure sensor 130, a second acceleration sensor 132, and a position sensor 134. The first acceleration sensor 126 may be disposed on the power cell 118 and configured to detect the acceleration of the power cell 118 during operation of the hydraulic hammer 102. The second acceleration sensor 132 may be disposed on the mounting bracket 110 and configured to detect the acceleration of the mounting bracket 110 during operation of the hydraulic hammer 102. The position sensor 134 may be disposed on the housing 116 and configured to detect the angular orientation “Q” of the hydraulic hammer 102 during operation thereof. The frequency measuring sensor 128 may be mounted on the power cell 118 and configured to detect the impact frequency “F” of the hydraulic hammer 102. The pressure sensor 130 may be disposed within the power cell 118 to detect the inlet pressure “P” of the hydraulic fluid.

It may be envisioned to one skilled in the art that a position and structural configuration of the sensors 124 of the damping system 122 is merely exemplary in nature and hence non-limiting to this disclosure. Moreover, the damping system 122 may embody any types of sensors known in the art and configured to function according to various embodiments of the present disclosure.

As shown in FIG. 2, the damping system 122 further includes an expandable bladder 136 that is positioned between the power cell 118 and an underside 138 of the mounting bracket 110. The expandable bladder 136 is configured to store a volume of pressurized fluid therein. In one embodiment, the pressurized fluid may be air. In another embodiment, the pressurized fluid may be a gas, for e.g., nitrogen. In an alternative embodiment, the pressurized fluid may be a liquid, for e.g., oil having suitable characteristics and/or of a specific grade for the required application. Optionally, the pressurized fluid disclosed herein, may also be a mixture containing air, gases, and/or liquids. For example, in one application, it may be helpful to use a mixture of nitrogen and a specific type of oil as the pressurized fluid.

In various embodiments disclosed herein, it may be noted that the exact specifications of the pressurized fluid may vary from one type and/or configuration of the hydraulic hammer 102 to another, and/or from one application to another depending on specific requirements of the associated application. Therefore, any type of fluid may be used to form the pressurized fluid disclosed herein without deviating from the scope of the present disclosure.

As shown in FIG. 2, the damping system 122 may further include a pump 140 disposed in fluid communication with the expandable bladder 136. The pump 140 is configured to supply pressurized fluid, via a conduit 137, to the expandable bladder 136. As the pressurized fluid may include any type of fluid therein, the type of pump employed in the damping system 122 is suitably selected to correspond with the type of fluid being used in the expandable bladder 136 of the hydraulic hammer 102. In an embodiment, the pump 140 may be configured to pressurize liquid phase alone. In another embodiment, the pump 140 may be configured to pressurize gaseous phase alone. In an alternative embodiment, the pump 140 may be of a type that is adapted to pressurize a mixture of liquid phase and gaseous phase.

As shown in FIG. 2, the damping system 122 further includes a controller 142 in communication with the plurality of sensors 124 and the pump 140. In particular, the controller 142 communicates with the each of the first acceleration sensor 126, the frequency measuring sensor 128, the pressure sensor 130, the second acceleration sensor 132, and the second acceleration sensor 132 though multiple communication links 127, 129, 131, 133, and 135, respectively. The controller 142 further communicates with the pump 140 through a communication link 141. It may herein be noted that the multiple communication links 127, 129, 131, 133, and 135 may enable wired or wireless communication between the controller 142 and the first acceleration sensor 126, the frequency measuring sensor 128, the pressure sensor 130, the second acceleration sensor 132, and the second acceleration sensor 132 respectively. Therefore, it is envisioned that the controller 142 may be remotely located from the hydraulic hammer system 101 at any location on the machine 100.

The controller 142 may be an electronic controller that operates in a logical fashion to perform operations, execute control algorithms, store and retrieve data and other desired operations. The controller 142 may include or access memory, secondary storage devices, processors, and any other components for running an application. The memory and secondary storage devices may be in the form of read-only memory (ROM) or random access memory (RAM) or integrated circuitry that is accessible by the controller 142. Various other circuits may be associated with the controller 142 such as power supply circuitry, signal conditioning circuitry, driver circuitry, and other types of circuitry.

The controller 142 may be a single controller or may include more than one controller disposed to control various functions and/or features of the damping system 122 and/or the machine 100. The term “controller 142” is meant to be used in its broadest sense to include one or more controllers and/or microprocessors that may be associated with the machine 100 and that may cooperate in controlling various functions and operations of the damping system 122 and/or the machine 100. The functionality of the controller 142 may be implemented in hardware and/or software without regard to the functionality employed.

During operation of the hydraulic hammer 102, the controller 142 is configured to receive the one or more inputs indicative of the parameters generated from the sensors 124. Specifically, the one or more inputs indicative of the parameters generated received by the controller 142 transmitted by the sensors 124 may include inputs pertaining to the acceleration of the power cell 118, the inlet pressure of the hydraulic fluid, the angular orientation “Q” of the hydraulic hammer 102 with respect to the ground surface 111, the acceleration of the mounting bracket 110, and the impact frequency of the hydraulic hammer 102. Further, based on the one or more inputs indicative of the parameters generated from the sensors 124, the controller 142 may determine a threshold volume of pressurized fluid to be maintained in the expandable bladder 136. The controller 142, upon determining the threshold volume of pressurized fluid accordingly, may actuate the pump 140 to supply the threshold volume of pressurized fuel to the expandable bladder 136. In an embodiment, the controller 142 may be configured to monitor a volume of pressurized fluid stored in the expandable bladder 136 and, accordingly, actuate the pump 140 to supply a desired amount of pressurized fluid to the expandable bladder 136 based on the threshold volume of pressurized fluid. The controller 142 may also discharge pressurized fluid from the expandable bladder 136 based on the threshold volume of pressurized fluid to be maintained in the expandable bladder 136.

In an embodiment of FIG. 2, the damping system 122 may include a servo actuator 144 in communication with the controller 142 and the pump 140. The servo actuator 144 is connected between the pump 140 and the expandable bladder 136 on the conduit 137. The servo actuator 144 may be configured to actuate the pump 140 based on a signal received from the controller 142 via a communication link 145. The servo actuator 144 may be any device that allows remote actuation of the pump 140 to supply pressurized fluid into the expandable bladder 136.

It is hereby envisioned that the pressurized fluid maintained in the expandable bladder 136 will allow the expandable bladder 136 to damp vibrations from the power cell 118 of the hydraulic hammer 102. This way, the vibrations from the power cell 118 may be prevented from transmitting to the cab 114. Therefore, the damping system 122 may prevent transmission of vibrations from the hydraulic hammer 102 by maintaining, during operation of the hydraulic hammer 102, the threshold volume of pressurized fluid in the expandable bladder 136 based on the operating conditions of the hydraulic hammer 102.

Moreover, the expandable bladder 136 may be beneficially made from an elastomeric material such as Neoprene, Rubber, and other types of elastomers commonly known to one skilled in the art. The expandable nature of the expandable bladder 136 may allow the controller 142 to selectively switch, via the servo actuator 144, the pump 140 “ON” or “OFF” and vary the amount of pressurized fluid in the expandable bladder 136.

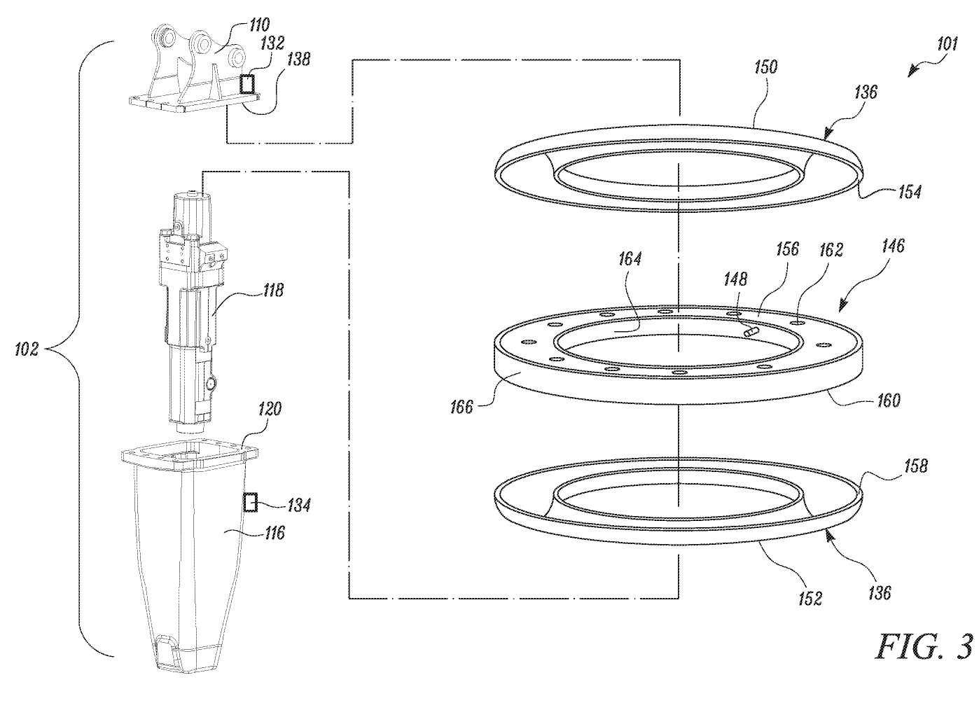

In an embodiment as shown in FIG. 3, the damping system 122 may further include a retainer 146 that is associated with the expandable bladder 136. The retainer 146 may be configured to retain a form and fit of the expandable bladder 136 within the housing 116 of the hydraulic hammer 102. As shown, the retainer 146 is in the shape of an annular rim. In an example, the retainer 146 may be made of metal. In other examples, the retainer 146 may be made of other materials such as fibre glass to suit a specific requirement of the application.

The retainer 146 includes at least one port 148 that is disposed in fluid communication with the expandable bladder 136. In the illustrated embodiment, the retainer 146 includes one port 148. The port 148 may be configured to receive the pressurized fluid and discharge the pressurized fluid into the expandable bladder 136. The port 148 may be fluidly coupled to the pump 140, via the conduit 137, to receive the pressurized fluid. The port 148 may also be configured to allow a discharge of the pressurized fluid from the expandable bladder 136 for a softer response to the vibrations. In such a case, the port 148 may discharge the pressurized fluid from the expandable bladder 136 based on an actuation of the controller 142, via the servo actuator 144.

Further, as shown in the illustrated embodiment of FIG. 3, the expandable bladder 136 includes a top portion 150 and a bottom portion 152. The top portion 150 has a first rimmed end 154 that is configured to engage with a top side 156 of the retainer 146 while the bottom portion 152 has a second rimmed end 158 that is configured to engage with a bottom side 160 of the retainer 146. Each of the top portion 150 and the bottom portion 152 of the expandable bladder 136 is annular in shape to conform to the annular shape of the retainer 146. In such a case, the retainer 146 may further include at least one vent port 162 to allow a passage of the pressurized fluid received via the port 148 to both the top portion 150 and the bottom portion 152 of the expandable bladder 136.

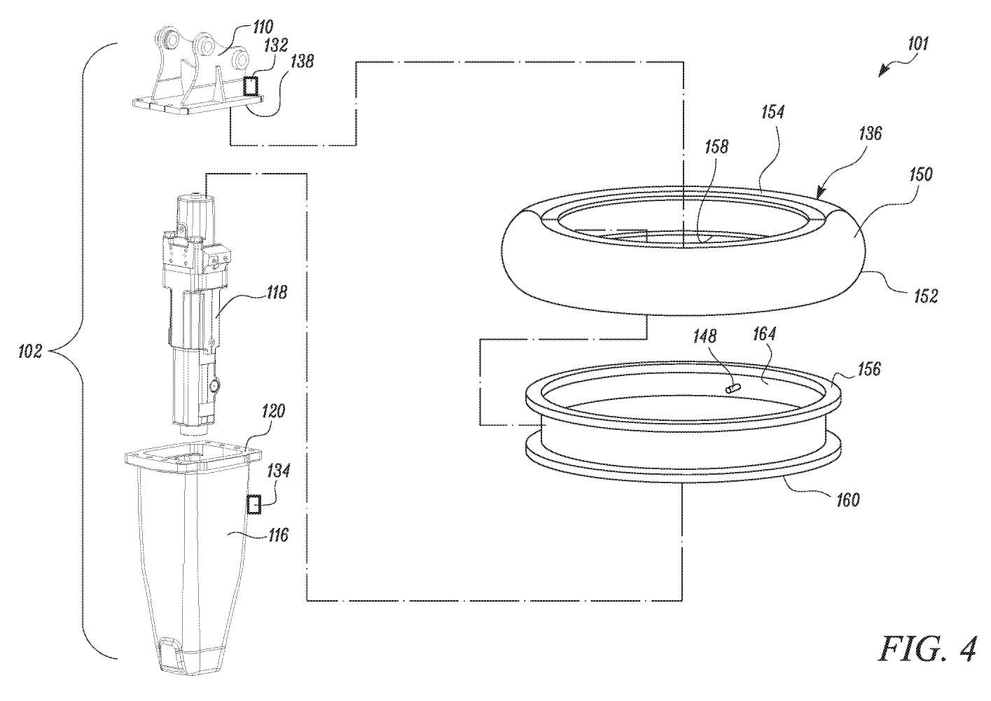

In another embodiment as shown in FIG. 4, the retainer 146 may be configured such that the port 148 is located on an inner surface 164 similar to that shown in the illustrated embodiment of FIG. 3. Moreover, as shown in the illustrated embodiment of FIG. 4, the top portion 150 of the expandable bladder 136 and the bottom portion 152 of the expandable bladder 136 may be integral with one another so as to impart a unitary construction to the expandable bladder 136.

Various embodiments disclosed herein are to be taken in the illustrative and explanatory sense, and should in no way be construed as unduly limiting of the present disclosure. All directional references (e.g., above, below, upper, lower, top, bottom, vertical, horizontal, inward, outward, radial, upward, downward, left, right, leftward, rightward, clockwise, and counter-clockwise) are only used for identification purposes to aid the reader's understanding of the present disclosure, and may not create limitations, particularly as to the position, orientation, or use of the systems and/or methods disclosed herein. Joinder references (e.g., attached, affixed, coupled, engaged, connected, and the like) are to be construed broadly. Moreover, such joinder references do not necessarily infer that two elements are directly connected to each other.

Additionally, all numerical terms, such as, but not limited to, “first”, “second”, “third”, or any other ordinary and/or numerical terms, should also be taken only as identifiers, to assist the reader's understanding of the various embodiments, variations, components, and/or modifications of the present disclosure, and may not create any limitations, particularly as to the order, or preference, of any embodiment, variation, component and/or modification relative to, or over, another embodiment, variation, component and/or modification.

It is to be understood that individual features shown or described for one embodiment may be combined with individual features shown or described for another embodiment. The above described implementation does not in any way limit the scope of the present disclosure. Therefore, it is to be understood although some features are shown or described to illustrate the use of the present disclosure in the context of functional segments, such features may be omitted from the scope of the present disclosure without departing from the spirit of the present disclosure as defined in the appended claims.

### INDUSTRIAL APPLICABILITY

The damping system 122 of the present disclosure has applicability in damping vibrations experienced during operation of the hydraulic hammer 102. In an aspect of the present disclosure, the damping system 122 of the present disclosure is configured to maintain varying amounts of pressurized fluid therein so as to accomplish a varying amount of damping i.e., underdamping, overdamping, and critically damping, to the vibrations from the hydraulic damper. This ability to adjust i.e., increase or decrease the amount of damping to the vibrations on real time basis prevents transmissions of vibration from the hydraulic hammer 102 to the cab 114 during operation thereof. Depending on the amount of pressurized fluid maintained in the expandable bladder 136, vibrations from the power cell 118 may be underdamped, critically damped, or overdamped.

The controller 142 may communicate with each of the sensors 124, the pump 140, and the servo actuator 144 through communication links 127, 129, 131, 133, 135, 141, and 145 to receive the one or more inputs indicative of the operating conditions of the hydraulic hammer 102. The controller 142 may pre-determine the threshold volume of pressurized fluid that is to be maintained in the expandable bladder 136 depending on the operating conditions of the hydraulic hammer 102. For example, if the controller 142 detects a change in the operating conditions which may cause a higher amount of vibrations, the controller 142 may actuate the servo actuator 144 to fill the expandable bladder 136 with more pressurized fluid so as to underdamp the vibrations. However, if the controller 142 detects a change in the operating conditions which may cause a moderate amount of vibrations, the controller 142 may actuate the port 148 to discharge the pressurized fluid for a softer response to the vibrations. This way, the vibrations from the hydraulic hammer 102 may be critically damped or over damped and therefore, little or no vibrations may be transmitted to the cab 114 when operating the hydraulic hammer 102.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof.

What is claimed is:

1. A damping system for a power cell of a hydraulic hammer, the hydraulic hammer having a housing and a mounting bracket disposed on a top end of the housing, the damping system comprising:
an expandable bladder positioned between the power cell and the mounting bracket, the expandable bladder configured to:
receive a supply of pressurized fluid; and
store a volume of pressurized fluid therein;
a plurality of sensors for detecting one or more parameters related to operating conditions of the hydraulic hammer; and
a controller in communication with the plurality of sensors, the controller configured to:
receive one or more inputs indicative of the one or more parameters from the plurality of sensors to determine a threshold volume of pressurised fluid to be maintained in the expandable bladder; and
supply the threshold volume of pressurized fluid to the expandable bladder during operation of the hydraulic hammer.

2. The damping system of claim 1 further comprising a pump in communication with the expandable bladder and the controller, the pump being configured to supply pressurized fluid to the expandable bladder.

3. The damping system of claim 2, wherein the controller is configured to actuate the pump to supply pressurized fluid to the expandable bladder to maintain the threshold volume of pressurized fluid in the expandable bladder.

4. The damping system of claim 1, wherein the one or more parameters comprises an acceleration of the power cell, an inlet pressure within the power cell, an angular orientation of the hydraulic hammer, an acceleration of the mounting bracket, and an impact frequency of the hydraulic hammer.

5. The damping system of claim 4, wherein the plurality of sensors comprises a first acceleration sensor configured to detect the acceleration of the power cell.

6. The damping system of claim 4, wherein the plurality of sensors comprises a second acceleration sensor configured to detect the acceleration of the mounting bracket.

7. The damping system of claim 4, wherein the plurality of sensors comprises a frequency measuring sensor configured to detect the impact frequency of the hydraulic hammer.

8. The damping system of claim 4, wherein the plurality of sensors comprises a pressure sensor configured to detect the inlet pressure of within the power cell.

9. The damping system of claim 4, wherein the plurality of sensors comprises a position sensor configured to detect the orientation of the hydraulic hammer.

10. A hydraulic hammer system comprising:
a hydraulic hammer comprising:
a housing;
a mounting bracket disposed on a top side of the housing; and
a power cell disposed within the housing; and
a damping system for damping vibrations during operation of the hydraulic hammer, the damping system comprising:
an expandable bladder positioned between the power cell and the mounting bracket, the expandable bladder configured to:
receive a supply of pressurized fluid; and
store a volume of pressurized fluid therein;
a plurality of sensors for detecting one or more parameters related to operating conditions of the hydraulic hammer; and
a controller disposed in communication with the plurality of sensors, the controller configured to:
receive one or more inputs indicative of the one or more parameters from the plurality of sensors to determine a threshold volume of pressurised fluid to be maintained in the expandable bladder; and
supply the threshold volume of pressurized fluid to the expandable bladder during an operation of the hydraulic hammer.

11. The hydraulic hammer system of claim 10 further comprising a pump disposed in fluid communication with the expandable bladder, the pump configured to supply pressurized fluid to the expandable bladder based on the threshold volume determined by the controller.

12. The hydraulic hammer system of claim 10, wherein the one or more parameters comprises an acceleration of the power cell, a pressure within the power cell, an angular orientation of the hydraulic hammer, an acceleration of the mounting bracket, an impact frequency of the hydraulic hammer.

13. The damping system of claim 12, wherein the plurality of sensors comprises a first acceleration sensor configured to detect the acceleration of the power cell.

14. The damping system of claim 12, wherein the plurality of sensors comprises a second acceleration sensor configured to detect the acceleration of the mounting bracket.

15. The damping system of claim 12, wherein the plurality of sensors comprises a frequency measuring sensor configured to detect the impact frequency of the hydraulic hammer.

16. The damping system of claim 12, wherein the plurality of sensors comprises a pressure sensor configured to detect the inlet pressure of hydraulic fluid in the power cell.

17. The damping system of claim 12, wherein the plurality of sensors comprises a position sensor configured to detect the orientation of the hydraulic hammer.

18. A machine for penetrating work surfaces, the machine comprising:
a hydraulic hammer system comprising:
a hydraulic hammer having a power cell enclosed within a housing, the hydraulic hammer further comprising a mounting bracket disposed on a top side of the housing; and
a damping system configured to damp vibrations from the hydraulic hammer to a frame of the machine, the damping system comprising:
an expandable bladder disposed between the power cell and an underside of the mounting bracket, the expandable bladder configured to store a volume of pressurized fluid therein;
a pump disposed in fluid communication with the expandable bladder, the pump configured to supply pressurized fluid to the expandable bladder;
a plurality of sensors disposed with the hydraulic hammer, the plurality of sensors configured to detect one or more parameters related to operating conditions of the hydraulic hammer; and
a controller disposed in communication with the plurality of sensors and the pump, the controller configured to:
receive one or more inputs indicative of the one or more parameters from the plurality of sensors, to determine a threshold volume of pressurised fluid to be maintained in the expandable bladder; and
supply the threshold volume of pressurized fluid to the expandable bladder by actuating the pump during an operation of the hydraulic hammer.

19. The machine of claim 18, wherein the one or more parameters comprises an acceleration of the power cell, a pressure within the power cell, an angular orientation of the hydraulic hammer, an acceleration of the mounting bracket, an impact frequency of the hydraulic hammer.

20. The damping system of claim 19, wherein the plurality of sensors comprises:
a first acceleration sensor configured to detect the acceleration of the power cell;
a second acceleration sensor configured to detect the acceleration of the mounting bracket;
a frequency measuring sensor configured to detect the impact frequency of the hydraulic hammer;
a pressure sensor configured to detect the inlet pressure of hydraulic fluid in the power cell; and
a position sensor configured to detect the orientation of the hydraulic hammer.
